(19) United States
(12) Patent Application Publication
(10) Pub. No.: US 2022/0385096 A1
(43) Pub. Date: Dec. 1, 2022

(54) BATTERY CONTROL CIRCUIT, BATTERY, AND RELATED ELECTRONIC DEVICE

(71) Applicant: Huawei Digital Power Technologies Co., Ltd., Futian District, (CN)

(72) Inventors: Baoguo CHEN, Dongguan (CN); Jianhua ZHU, Dongguan (CN)

(21) Appl. No.: 17/825,602

(22) Filed: May 26, 2022

(30) Foreign Application Priority Data
May 27, 2021 (CN) 202110587576.2

(51) Int. Cl. H02J 7/00; H01M 10/48; H01M 10/44; H01M 10/637

(52) U.S. Cl. CPC H02J 7/007194; H02J 7/0013; H02J 7/0047; H02J 7/00714; H01M 10/482; H01M 10/486; H01M 10/441; H01M 10/443; H01M 10/637

(57) ABSTRACT

The battery control circuit includes a first inductor, a first switch tube, a second switch tube, a first diode, and a second diode. A first terminal of the first switch tube and a cathode of the first diode are both coupled to the positive electrode of the battery pack, and a second terminal of the first switch tube is coupled to a terminal of the first inductor and a cathode of the second diode. An anode of the first diode is coupled to another terminal of the first inductor and a first terminal of the second switch tube, and a second terminal of the second switch tube and an anode of the second diode are both coupled to the negative electrode of the battery pack. The first switch tube and the second switch tube are simultaneously turned on or turned off.

### CROSS-REFERENCE TO RELATED APPLICATION

This application claims priority to Chinese Patent Application No. 202110587576.2, filed on May 27, 2021, which is hereby incorporated by reference in its entirety.

### TECHNICAL FIELD

This application relates to the field of battery technologies, and in particular, to a battery control circuit, a battery, and a related electronic device.

### BACKGROUND

Lithium-ion batteries (batteries for short) have advantages of high cycle life, high energy density, and high charging/discharging rates. However, in a low-temperature environment, an internal resistance of a battery increases, a capacity rapidly decays, and there is a risk of lithium dissipation at a negative electrode of the battery when the battery is charged at a low temperature. In other words, the battery cannot work normally in the low-temperature environment. To enable the battery to work normally at a low temperature, the battery may be heated first, and the battery may be charged or discharged only after a temperature of the battery reaches a temperature required for a normal operation.

In a conventional technology, an external heater or heating box is disposed around the battery to raise an ambient temperature around the battery to heat the battery. The inventor of this application finds that heating efficiency of the battery in the conventional technology is too low.

### SUMMARY

This application provides a battery control circuit, a battery, and a related electronic device to implement charging and discharging by using energy of a battery pack. Currents of charging and discharging both generate Joule heat on an internal resistance of the battery pack to heat the battery. Therefore, heating efficiency is high.

According to a first aspect, this application provides a battery control circuit. The battery control circuit is connected in parallel between a positive electrode and a negative electrode of a battery pack, and the battery control circuit includes a first inductor, a first switch tube, a second switch tube, a first diode, and a second diode. A first terminal of the first switch tube and a cathode of the first diode are both coupled to the positive electrode of the battery pack, and a second terminal of the first switch tube is coupled to a terminal of the first inductor and a cathode of the second diode. An anode of the first diode is coupled to another terminal of the first inductor and a first terminal of the second switch tube, and a second terminal of the second switch tube and an anode of the second diode are both coupled to the negative electrode of the battery pack. During specific implementation, the first switch tube and the second switch tube are simultaneously turned on and the battery pack is in a discharging state, or the first switch tube and the second switch tube are simultaneously turned off and the battery pack is in a charging state. Because the battery pack has an internal resistance, a current flows through the internal resistance of the battery pack regardless of whether the battery pack is in the discharging state or the charging state. The internal resistance generates Joule heat to heat the battery. In other words, in this embodiment of this application, the battery control circuit only needs to control the two switch tubes to be simultaneously turned on or turned off to implement charging and discharging by using energy of the battery pack. Currents of charging and discharging both generate heat on the internal resistance of the battery pack to heat the battery. Therefore, heating efficiency is high, a small quantity of switch tubes are used, driving control is simple, and costs are low. Furthermore, the first switch tube and the second switch tube are not on a same bridge arm. Therefore, there is no risk of a short circuit caused by a direct connection between an upper tube and a lower tube of one bridge arm, and safety is high.

It may be understood that when an ambient temperature of the battery is lower than a temperature required for a normal operation of the battery, the battery control circuit provided in this embodiment of this application may first be used to heat the battery, and then the battery interacts with the outside (for example, with at least one of a load and a charger). Further, when the battery interacts with the outside, for example, is discharged to the load or is charged by the charger, because the battery control circuit provided in this embodiment of this application is connected in parallel between the positive electrode and the negative electrode of the battery, an interaction between the battery control circuit and the battery does not conflict with the interaction between the battery and the outside. In other words, when the battery interacts with the outside, the battery pack may still be charged and discharged by using the battery control circuit provided in this embodiment of this application, to heat the battery. However, it should be noted that even if the battery is connected to a load and is discharged to the load, a current flows through the internal resistance of the battery pack, but a magnitude of the current is affected by the load. If a resistance value of the load is large and the current flowing through the internal resistance of the battery pack is small, energy for beating the battery is insufficient and reliability is poor. For another example, even if the battery is connected to a charger, if a charging current of the charger is small, the current flowing through the internal resistance of the battery pack is also small and energy for heating the battery is still insufficient. Therefore, in this embodiment of this application, the battery may be heated without relying on the outside. Instead, charging and discharging of the battery pack are implemented by using energy of the battery pack and the battery control circuit that is provided in this embodiment of this application. The currents of charging and discharging both generate heat on the internal resistance of the battery pack to heat the battery. This is easy and reliable.

In one embodiment, the battery control circuit further includes a control module, and the control module is coupled to a third terminal of the first switch tube and a third terminal of the second switch tube.

In one embodiment, the battery control circuit further includes a temperature detection module. The temperature detection module may detect a temperature of the battery pack, and send the temperature of the battery pack to the control module. When the temperature of the battery pack is lower than a preset temperature, the control module may control the first switch tube and the second switch tube to simultaneously switch between an on state and off state at a preset frequency. During specific implementation, the control module controls the first switch tube and the second switch tube to be simultaneously turned on, the battery pack is in a discharging state, and some energy of the battery pack is transferred to the first inductor (that is, the battery pack excites the first inductor). However, after the first inductor saturated, even if the first switch tube and the second switch tube are still in an on state, a discharging current of the battery pack cannot pass through the first inductor, in other words, the first inductor terminates discharging of the battery pack after becoming saturated. However, the control module may control the first switch tube and the second switch tube to be simultaneously turned off, so that some energy on the first inductor is transferred to the battery pack (that is, the first inductor is demagnetized). In other words, the first inductor charges the battery pack. In this case, the battery pack not only recycles the energy of the battery pack but also releases the energy on the first inductor, so that the first inductor can accept energy transferred by the battery pack when the battery pack is discharged again. In this way, the battery pack is discharged and charged repeatedly, and the battery is continuously heated. In other words, the control module switches the states of the first switch tube and the second switch tube to ensure continuity of discharging and charging of the battery pack and recycle the energy of the battery pack, thereby improving energy utilization in this embodiment of this application and ensuring good applicability.

In one embodiment, the battery control circuit further includes a current detection module. The current detection module may detect a current of the first inductor. The control module may obtain the current of the first inductor detected by the current detection module, and determine the preset frequency. In this embodiment of this application, in the battery control circuit, the preset frequency may be determined based on the current of the first inductor. Therefore, charging and discharging of the battery pack can be better controlled, and the energy utilization of the battery pack can be improved.

In one embodiment, during specific implementation, the preset frequency may be determined by the control module based on a time interval between a first moment and a second moment, the first moment is a moment at which the control module detects that the current of the first inductor increases to a first preset current, and the second moment is a moment at which the control module detects that the current of the first inductor decreases to a second preset current.

According to a second aspect, this application provides a battery control circuit. The battery control circuit is connected in parallel between a positive electrode and a negative electrode of a battery pack, the battery control circuit includes a first inductor, a first switch tube, and a second switch tube, the first inductor includes a first winding and a second winding, and a first terminal of the first winding and a first terminal of the second winding are dotted terminals. It may be understood that the dotted terminals mean that alternating currents are supplied to the first winding and the second winding separately to generate magnetic fields. When flux directions of magnetic fields generated by two windings are the same, terminals into which currents of the two windings flow are dotted terminals of the two windings. The first terminal of the first winding is coupled to the positive electrode of the battery pack, a second terminal of the first winding is coupled to a first terminal of the first switch tube, and a second terminal of the first switch tube is coupled to the negative electrode of the battery pack. A second terminal of the second winding is coupled to the positive electrode of the battery pack, the first terminal of the second winding is coupled to a first terminal of the second switch tube, and a second terminal of the second switch tube is coupled to the negative electrode of the battery pack. During specific implementation, the first switch tube and the second switch tube are alternately turned on. This embodiment of this application is another possible implementation of the battery control circuit. Because the first switch tube and the second switch tube are alternately turned on, heating of the switch tubes is even, safety of the battery control circuit is good, and reliability is high.

In one embodiment, when the first switch tube is turned on and the second switch tube is turned off, the battery pack is in a discharging state; or when the second switch tube is turned on and the first switch tube is turned off, the battery pack is in a charging state.

In one embodiment, when the first switch tube is turned on and the second switch tube is turned off, if a current direction of the first winding is a first direction, the battery pack is in a discharging state; when the second switch tube is turned on and the first switch tube is turned off, if a current direction of the second winding is a second direction, the battery pack is in a charging state; when the second switch tube is turned on and the first switch tube is turned off, if a current direction of the second winding is a first direction, the battery pack is in a discharging state; or when the first switch tube is turned on and the second switch tube is turned off, if a current direction of the first winding is a second direction, the battery pack is in a charging state, where the first direction is opposite to the second direction. A difference between this embodiment of this application and the first possible implementation of the second aspect is that when the first switch tube is turned on and the second switch tube is turned off, the battery pack may be in the discharging state or the charging state; and when the second switch tube is turned on and the first switch tube is turned off, the battery pack may be in the charging state or the discharging state. As can be learned, because on/off states of the switch tubes are the same (to be specific, the second switch tube is turned on and the first switch tube is turned off or the first switch tube is turned on and the second switch tube is turned off) in the charging state and the discharging state, the on/off states of the switch tubes do not need to be frequently switched. Therefore, a switch loss is reduced, and heating efficiency of the battery control circuit is further improved.

In one embodiment, the battery control circuit further includes a control module, and the control module is coupled to a third terminal of the first switch tube and a third terminal of the second switch tube.

In one embodiment, the battery control circuit further includes a temperature detection module. The temperature detection module may detect a temperature of the battery pack, and send the temperature of the battery pack to the control module. When the temperature of the battery pack is lower than a preset temperature, the control module may control, at a preset frequency, the first switch tube and the second switch tube to be alternately turned on.

In one embodiment, the battery control circuit further includes a current detection module. The current detection module may detect a current of the first winding and a current of the second winding. The control module may obtain the current of the first winding and the current of the second winding that are detected by the current detection module, and determine the preset frequency.

In one embodiment, the preset frequency may be determined by the control module based on a time interval between a first moment and a second moment, the first moment is a moment at which the control module detects that the current of the first inductor increases to a first preset current, and the second moment is a moment at which the control module detects that the current of the first inductor decreases to a second preset current.

According to a third aspect, this application provides a battery control circuit. The battery control circuit includes a first electrochemical cell and a second electrochemical cell. A positive electrode of the first electrochemical cell is coupled to a negative electrode of the second electrochemical cell, the battery control circuit includes a first inductor, a first switch tube, and a second switch tube, the first inductor includes a first winding and a second winding, and a first terminal of the first winding and a first terminal of the second winding are dotted terminals. It may be understood that the dotted terminals mean that alternating currents are supplied to the first winding and the second winding separately to generate magnetic fields. When flux directions of magnetic fields generated by two windings are the same, terminals into which currents of the two windings flow are dotted terminals of the two windings. The first terminal of the first winding is coupled to a positive electrode of the second electrochemical cell, a second terminal of the first winding is coupled to a first terminal of the first switch tube, and a second terminal of the first switch tube is coupled to a negative electrode of the first electrochemical cell. A second terminal of the second winding is coupled to the positive electrode of the first electrochemical cell, a first terminal of the second winding is coupled to a first terminal of the second switch tube, and a second terminal of the second switch tube is coupled to the negative electrode of the first electrochemical cell. During specific implementation, the first switch tube and the second switch tube are alternately turned on. In this embodiment of this application, the first electrochemical cell and the second electrochemical cell are simultaneously discharged, and only the first electrochemical cell is charged; or only the first electrochemical cell is discharged, and the first electrochemical cell and the second electrochemical cell are simultaneously charged. In this case, an amount of heat generated by the first electrochemical cell is greater than an amount of heat generated by the second electrochemical cell. This embodiment of this application may be applicable to different electrochemical cells. For example, a temperature withstand of the first electrochemical cell is less than that of the second electrochemical cell, and an internal resistance of the first electrochemical cell is greater than that of the second electrochemical cell. In other words, this embodiment of this application can better adapt to differences between electrochemical cells and has good applicability.

In one embodiment, when the first switch tube is turned on and the second switch tube is turned off, the first electrochemical cell and the second electrochemical cell are in a discharging state; or when the second switch tube is turned on and the first switch tube is turned off, the first electrochemical cell is in a charging state.

In one embodiment, when the first switch tube is turned on and the second switch tube is turned off, if a current direction of the first winding is a first direction, the first electrochemical cell and the second electrochemical cell are both in a discharging state; when the second switch tube is turned on and the first switch tube is turned off, if a current direction of the second winding is a second direction, the first electrochemical cell is in a charging state; when the second switch tube is turned on and the first switch tube is turned off, if a current direction of the second winding is a first direction, the first electrochemical cell is in a discharging state; or when the first switch tube is turned on and the second switch tube is turned off, if a current direction of the first winding is a second direction, the first electrochemical cell and the second electrochemical cell are in a charging state.

In one embodiment, the battery control circuit includes a control module, and the control module is coupled to a third terminal of the first switch tube and a third terminal of the second switch tube.

In one embodiment, the battery control circuit further includes a temperature detection module. The temperature detection module may detect temperatures of the first electrochemical cell and the second electrochemical cell, and send the temperatures of the first electrochemical cell and the second electrochemical cell to the control module. When a temperature of at least one of the first electrochemical cell and the second electrochemical cell is lower than a preset temperature, the control module may control, at a preset frequency, the first switch tube and the second switch tube to be alternately turned on.

In one embodiment, the battery control circuit further includes a current detection module. The current detection module may detect a current of the first winding and a current of the second winding. The control module may obtain the current of the first winding and the current of the second winding that are detected by the current detection module, and determine the preset frequency.

In one embodiment, the preset frequency may be determined by the control module based on a time interval between a first moment and a second moment, the first moment is a moment at which the control module detects that the current of the first inductor increases to a first preset current, and the second moment is a moment at which the control module detects that the current of the first inductor decreases to a second preset current.

According to a fourth aspect, this application provides a battery. The battery includes a battery pack and the battery control circuit according to any one of the first aspect or the possible implementations with reference to the first aspect, the battery control circuit according to any one of the second aspect or the possible implementations with reference to the second aspect, or the battery control circuit according to any one of the third aspect or the possible implementations with reference to the third aspect.

According to a fifth aspect, this application provides an electronic device. The electronic device includes a load and the battery according to the fourth aspect. The battery may supply power to the load.

It should be understood that, for implementations and beneficial effects of the plurality of foregoing aspects of this application, reference may be made to each other.

### BRIEF DESCRIPTION OF DRAWINGS

FIG. 1 shows a battery according to an embodiment of this application;

FIG. 2 is a circuit principle diagram of a battery control circuit according to an embodiment of this application;

FIG. 3 is a schematic diagram of a waveform of a battery control circuit according to an embodiment of this application;

FIG. 4A and FIG. 4B are partial equivalent circuit diagrams of a battery control circuit according to an embodiment of this application;

FIG. 5 is another circuit principle diagram of a battery control circuit according to an embodiment of this application;

FIG. 6A and FIG. 6B are other schematic diagrams of waveforms of a battery control circuit according to an embodiment of this application;

FIG. 7A and FIG. 7B are other partial equivalent circuit diagrams of a battery control circuit according to an embodiment of this application;

FIG. 8 is another schematic diagram of a waveform of a battery control circuit according to an embodiment of this application;

FIG. 9A and FIG. 9B are other partial equivalent circuit diagrams of a battery control circuit according to an embodiment of this application;

FIG. 10 is another circuit principle diagram of a battery control circuit according to an embodiment of this application;

FIG. 11A to FIG. 11D are other partial equivalent circuit diagrams of a battery control circuit according to an embodiment of this application; and

FIG. 12 shows another battery according to an embodiment of this application.

### DESCRIPTION OF EMBODIMENTS

The following clearly and describes technical solutions in embodiments of this application with reference to accompanying drawings in embodiments of this application. Definitely, the described embodiments are some but not all of embodiments of this application. All other embodiments obtained by a person of ordinary skill in the art based on embodiments of this application without creative efforts shall fall within the protection scope of this application.

The following further describes implementations of technical solutions of this application in detail with reference to the accompanying drawings.

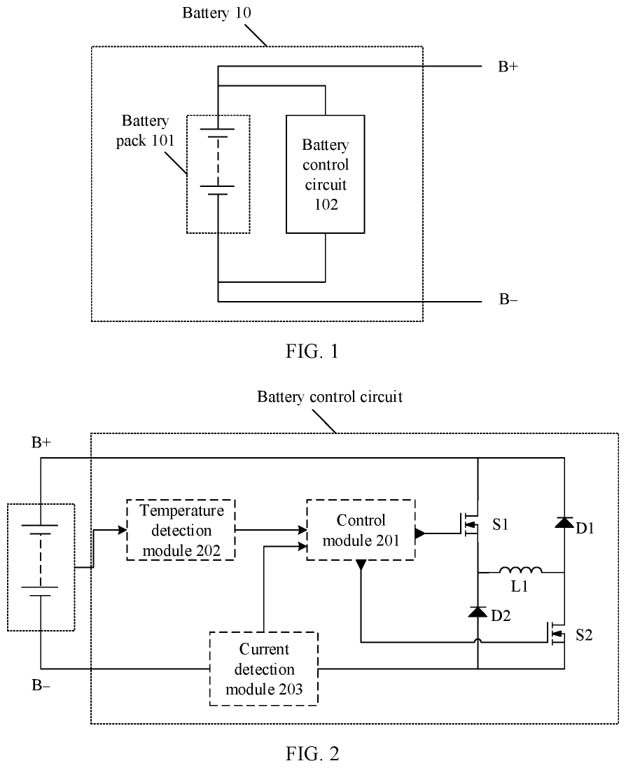

FIG. 1 shows a battery according to an embodiment of this application. As shown in FIG. 1, the battery 10 includes a battery pack 101 and a battery control circuit 102.

The battery pack 101 may include at least one electrochemical cell (which may also be referred to as a single battery). For example, during specific implementation, M electrochemical cells are connected in series or in parallel to form a module, and N modules are connected in series or in parallel to form a battery pack, where M and N are positive integers. Therefore, the battery pack in this embodiment of this application may also be referred to as batteries.

A battery control circuit 102 are connected in parallel between a positive electrode and a negative electrode of the battery pack 101. It may be understood that the positive electrode and the negative electrode of the battery pack 101 are a positive electrode B+ and a negative electrode B− of the battery 10. In this embodiment of this application, the battery control circuit 102 may be directly connected in parallel between the positive electrode and the negative electrode of the battery pack 101 without drawing an intermediate tap from the battery pack 101, thereby reducing complexity of battery pack assembly.

In one embodiment, the battery control circuit 102 may be provided by a manufacturer that manufactures the battery. That is, as shown in FIG. 1, the battery control circuit 102 and the battery pack 101 are connected to each other by using a soldering tape and are encapsulated together as a part of the battery 10. In other words, the battery 10 has a self-heating function.

In one embodiment, the battery control circuit may be disposed independently of the battery pack (not shown in the figure), and the battery control circuit is connected to the battery pack by using an electric wire. In other words, when the battery does not have a self-heating function, the battery control circuit provided in this embodiment of this application may be connected in parallel between the positive electrode and the negative electrode of the battery.

In one embodiment, the battery 10 may further include a battery management system BMS. The BMS may detect a temperature of the battery pack 101, obtain a residual electricity amount of the battery pack 101, obtain information such as a terminal voltage of the battery pack 101, and correspondingly control charging and discharging of the battery 10 based on the obtained information. For specific implementation, refer to a BMS control mechanism in a conventional technology. Details are not described herein.

In this embodiment of this application, charging and discharging may be implemented by using energy of the battery pack. Currents of charging and discharging both generate heat on an internal resistance of the battery pack to heat the battery.

The battery control circuit provided in embodiments of this application is described in detail below with reference to FIG. 2 to FIG. 12.

In one embodiment, FIG. 2 is a circuit principle diagram of a battery control circuit according to an embodiment of this application. As shown in FIG. 2, the battery control circuit provided in this embodiment of this application includes a first inductor L1, a first switch tube S1, a second switch tube S2, a first diode D1, and a second diode D2.

In this application, an example in which each switch tube is a metal-oxide-semiconductor field-effect transistor (Metal-Oxide-Semiconductor Field-Effect Transistor, MOSFET) is used for description. It should be understood that each switch tube may alternatively be a relay, a contactor, an insulated gate bipolar transistor (Insulated Gate Bipolar Transistor, IGBT), a triode, or the like.

In one embodiment, a first terminal (that is, a drain) of the first switch tube S1 and a cathode of the first diode D1 are both coupled to a positive electrode B+ of a battery pack, and a second terminal (that is, a source) of the first switch tube S1 is coupled to a terminal of the first inductor L1 and a cathode of the second diode D2. An anode of the first diode D1 is coupled to another terminal of the first inductor L1 and a first terminal (that is, a drain) of the second switch tube S2, and a second terminal (that is, a source) of the second switch tube S2 and an anode of the second diode D2 are both coupled to a negative electrode B− of the battery pack.

It should be noted that the “coupling” described in this application refers to a direct connection or an indirect connection. For example, a connection between A and B may be a direct connection between A and B or an indirect connection between A and B through one or more other electrical components. For example, A may be directly connected to C and C may be directly connected to B, so that A is connected to B through C.

In one embodiment, the battery control circuit in this embodiment of this application further includes a control module 201, and the control module 201 is coupled to a third terminal (that is, a gate) of the first switch tube S1 and a third terminal (that is, a gate) of the second switch tube S2. For example, the control module 201 may be a central processing unit (CPU), another general-purpose processor, a digital signal processor (DSP), an application-specific integrated circuit (ASIC), a field-programmable gate array (FPGA) or another programmable logic device, a discrete gate or transistor logic device, a discrete hardware component, or the like.

In one embodiment, the control module 201 may further be specifically implemented as a BMS in the battery. For specific implementation, refer to the BMS in a conventional technology. Details are not described herein.

In one embodiment, the battery control circuit further includes a temperature detection module 202. The temperature detection module 202 may detect a temperature of the battery pack. For example, the temperature detection module 202 may be specifically a temperature sensor, and the temperature sensor may be located on a surface of the battery pack. If the battery pack includes a plurality of electrochemical cells, the temperature detection module 202 is accordingly provided with a plurality of temperature sensors. A surface of each electrochemical cell is correspondingly provided with a temperature sensor, configured to detect a temperature of each electrochemical cell.

The temperature detection module 202 is coupled to the control module 201. The temperature detection module 202 may send the detected temperature of the battery pack to the control module 201. When the temperature of the battery pack is lower than a first preset temperature, the control module 201 controls the first switch tube S1 and the second switch tube S2 to simultaneously switch between an on state and an off state at a first preset frequency. It may be understood that the first preset temperature is a critical temperature at which the battery pack can work normally, is an inherent attribute of the battery pack, and is related to at least one factor in a manufacturer, a manufacturing process, and a battery model of the battery pack.

In one embodiment, when the first switch tube S1 and the second switch tube S2 are simultaneously turned on, the positive electrode B+ of the battery pack, the first switch tube S1, the first inductor L1, the second switch tube S2, and the negative electrode B− of the battery pack form a closed loop. In this case, the battery pack is in a discharging state. When the first switch tube S1 and the second switch tube S2 are simultaneously turned off, because currents at two terminals of an inductor cannot be changed suddenly, a current of the first inductor L1 passes through the first diode D1, the positive electrode B+ of the battery pack, the negative electrode B− of the battery pack, and the second diode D2 to form a closed loop. In this case, the first inductor L1 charges the battery pack, and the battery pack is in a charging state. It should be understood that a current direction of the battery pack in the discharging state is opposite to a current direction of the battery pack in the charging state.

In one embodiment, the first preset frequency is a constant value pre-configured by the control module 201. For example, the control module 201 controls, within a time period of 0 ms to 0.5 ms, the first switch tube S1 and the second switch tube S2 to be simultaneously turned on. In this case, the battery pack is in the discharging state. The control module 201 controls, within a time period of 0.5 ms to 1 ms, the first switch tube S1 and the second switch tube S2 to be simultaneously turned off. In this case, the battery pack is in the charging state. In other words, the control module 201 simultaneously switches the on/off state of the first switch tube S1 and the second switch tube S2 at a time periodicity of 1 ms, that is, the first preset frequency is 1 kHz. In this embodiment of this application, a time of switching from the on state to the off state of the first switch tube S1 and the second switch tube S2 is short. For example, the first preset frequency is at a level of kHz, and a switching periodicity is at a level of ms. In this way, accumulation of lithium ions in the battery pack at a negative electrode of an electrochemical cell can be reduced. In other words, this embodiment of this application can reduce a possibility of negative electrode lithium dissect that occurs when the battery is charged in a low-temperature environment, and safety is high.

In one embodiment, the battery control circuit further includes a current detection module 203. The current detection module 203 may detect the current of the first inductor L1. The control module 201 may obtain the current of the first inductor L1 detected by the current detection module 203, and determine the first preset frequency based on the current of the first inductor L1. For example, the current detection module 203 may be specifically a resistance, a current sensor, or the like. After controlling the first switch tube S1 and the second switch tube S2 to be simultaneously turned on, the control module 201 may obtain the current of the first inductor L1, and denote a moment at which the current of the first inductor L1 increases to a first preset current as a first moment T1; control, at the first moment T1, the first switch tube S1 and the second switch tube S2 to be simultaneously turned off, obtain the current of the first inductor L1, denote a moment at which the current of the first inductor L1 decreases to a second preset current as a second moment T2, and control, at the second moment T2, the first switch tube S1 and the second switch tube S2 to be simultaneously turned on. The control module 201 may determine the first preset frequency f1 based on a time interval between the first moment T1 and the second moment T2, that is, f1=1/(2*|T1−T2|). In this embodiment of this application, the first preset frequency may be determined in the battery control circuit. Therefore, charging and discharging of the battery pack can be better controlled, energy of the battery pack is efficiently used, and energy utilization of the battery pack is improved.

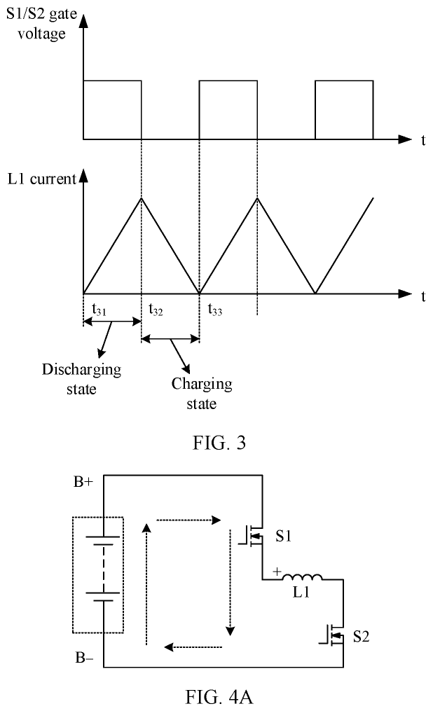

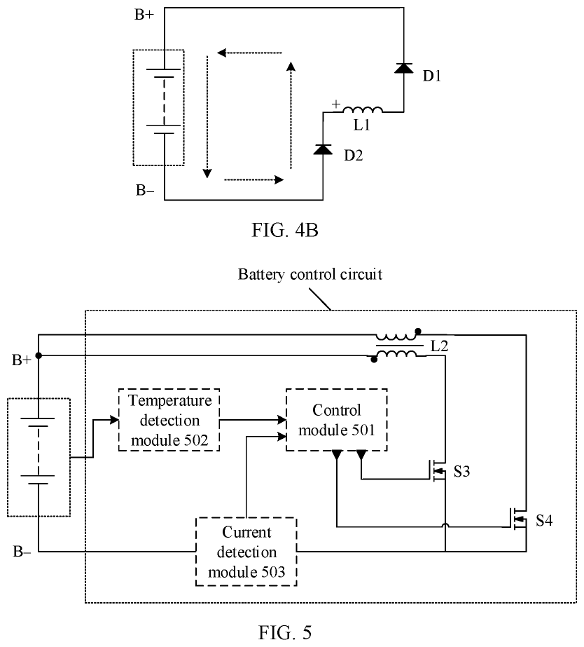

How the battery control circuit shown in FIG. 2 implements charging and discharging of the battery pack is described below by using examples with reference to FIG. 3 to FIG. 4B.

FIG. 3 is a schematic diagram of a waveform of a battery control circuit according to an embodiment of this application. As shown in FIG. 3, in a time period from t₃₁ to t₃₂, the control module 201 simultaneously sends a high electrical level to a third terminal (that is, a gate) of the first switch tube S1 and a third terminal (that is, a gate) of the second switch tube S2, and the first switch tube S1 and the second switch tube S2 are simultaneously turned on. In this case, for a partial equivalent circuit diagram of the battery control circuit shown in FIG. 2, refer to FIG. 4A. As shown in FIG. 4A, the battery pack is discharged, and the positive electrode B+ of the battery pack, the first switch tube S1, the first inductor L1, the second switch tube S2, and the negative electrode B− of the battery pack form a closed loop. In this case, a current of the closed loop excites the first inductor L1, and the current of the first inductor L1 increases. Moreover, the current of the closed loop flows through an internal resistance of the battery pack, and generates Joule heat on the internal resistance of the battery pack. In other words, the battery pack may be discharged through the battery control circuit to heat the battery.

In a time period from t₃₂ to t₃₃, the control module 201 simultaneously sends a low electrical level to the gate of the first switch tube S1 and the gate of the second switch tube S2, and the first switch tube S1 and the second switch tube S2 are simultaneously turned off. In this case, for a partial equivalent circuit diagram of the battery control circuit shown in FIG. 2, refer to FIG. 4B. As shown in FIG. 4B, the current of the first inductor L1 continues to flow, and the current of the first inductor L1 flows through the first diode D1, the positive electrode B+ of the battery pack, the negative electrode B− of the battery pack, and the second diode D2 to form a closed loop to charge the battery pack. In this case, the first inductor L1 is demagnetized, and the current of the first inductor L1 decreases. Moreover, the current of the closed loop also flows through the internal resistance of the battery pack, and generates Joule heat on the internal resistance of the battery. In other words, the battery pack may be charged through the battery control circuit to heat the battery.

In other words, in this embodiment of this application, the battery control circuit only needs to control the two switch tubes to be simultaneously turned on or turned off, that is, the first switch tube and the second switch tube are both at a high electrical level (that is, are simultaneously turned on) or are both at a low electrical level (that is, are simultaneously turned off), to implement charging and discharging by using energy of the battery pack. Currents of charging and discharging both generate heat on the internal resistance of the battery pack to heat the battery. Therefore, heating efficiency is high. In addition, a small quantity of switch tubes are used, driving control is simple, and costs are low. Furthermore, the first switch tube and the second switch tube are not on a same bridge arm. Therefore, there is no risk of a short circuit caused by a direct connection between an upper tube and a lower tube, the circuit is simple and reliable, and safety is high.

In one embodiment, FIG. 5 is another circuit principle diagram of a battery control circuit according to an embodiment of this application. As shown in FIG. 5, the battery control circuit is connected in parallel between a positive electrode B+ of a battery pack and a negative electrode B− of the battery pack. The battery control circuit includes a first inductor L2, a first switch tube S3, and a second switch tube S4, the first inductor L2 includes a first winding and a second winding, and a first terminal of the first winding and a first terminal of the second winding are dotted terminals.

For example, the first switch tube S3 and the second switch tube S4 are MOSFETs. During specific implementation, the first terminal of the first winding is coupled to the positive electrode B+ of the battery pack, a second terminal of the first winding is coupled to a first terminal (that is, a drain) of the first switch tube S3, and a second terminal (that is, a source) of the first switch tube S3 is coupled to the negative electrode B− of the battery pack. A second terminal of the second winding is coupled to the positive electrode B+ of the battery pack, the first terminal of the second winding is coupled to a first terminal (that is, a drain) of the second switch tube S4, and a second terminal (that is, a source) of the second switch tube S4 is coupled to the negative electrode B− of the battery pack.

In one embodiment, the battery control circuit in this embodiment of this application further includes a control module 501, and the control module 501 is coupled to a third terminal (that is, a gate) of the first switch tube S3 and a third terminal (that is, a gate) of the second switch tube S4. For example, the control module 501 may be a central processing unit (CPU), another general-purpose processor, a digital signal processor (DSP), an application-specific integrated circuit (ASIC), a field-programmable gate array (FPGA) or another programmable logic device, a discrete gate or transistor logic device, a discrete hardware component, or the like.

In one embodiment, the control module 501 may further be specifically implemented as a BMS in the battery. For specific implementation, refer to the BMS in a conventional technology. Details are not described herein.

Further, in one embodiment, the battery control circuit further includes a temperature detection module 502. The temperature detection module 502 may detect a temperature of the battery pack. For example, the temperature detection module 502 may be specifically a temperature sensor, and the temperature sensor may be located on a surface of the battery pack. If the battery pack includes a plurality of electrochemical cells, the temperature detection module 502 is accordingly provided with a plurality of temperature sensors. A surface of each electrochemical cell is correspondingly provided with a temperature sensor, configured to detect a temperature of each electrochemical cell.

The temperature detection module 502 is coupled to the control module 501. The temperature detection module 502 may send the detected temperature of the battery pack to the control module 501. When the temperature of the battery pack is lower than a second preset temperature, the control module 501 controls, at a second preset frequency, the first switch tube S3 and the second switch tube S4 to be alternately turned on. It may be understood that the second preset temperature is a critical temperature at which the battery pack can work normally, is an inherent attribute of the battery pack, and is related to at least one factor in a manufacturer, a manufacturing process, and a battery model of the battery pack.

In one embodiment, when the first switch tube S3 is turned on and the second switch tube S4 is turned off, the positive electrode B+ of the battery pack, the first winding, the first switch tube S3, and the negative electrode B− of the battery pack may form a closed loop. In this case, the battery pack is in a discharging state, and a current of the first winding increases along a first direction. When the second switch tube S4 is turned on and the first switch tube S3 is turned off, energy obtained by the first winding in the first inductor L2 when the battery pack is in the discharging state is released through the second winding in the first inductor L2. That is, the second winding, the positive electrode B+ of the battery pack, the negative electrode B− of the battery pack, and the second switch tube S4 form a closed loop. The second winding charges the battery pack. In this case, the battery pack is in a charging state, and a current of the second winding decreases along a second direction. The first direction is opposite to the second direction. That is, a current direction of the battery pack in the discharging state is opposite to a current direction of the battery pack in the charging state.

For example, the second preset frequency is a constant value pre-configured by the control module 501. For example, the control module 501 controls, within a time period of 0 ms to 0.1 ms, the first switch tube S3 to be turned on and the second switch tube S4 to be turned off. In this case, the battery pack is in the discharging state. The control module 501 controls, within a time period of 0.1 ms to 0.2 ms, the first switch tube S3 to be turned off and the second switch tube S4 to be turned on. In this case, the battery pack is in the charging state. The battery pack completes a time of charging and discharging within a time period of 0 ms to 0.2 ms. Similarly, the control module 501 controls, within a time period of 0.2 ms to 0.3 ms, the first switch tube S3 to be turned on and the second switch tube S4 to be turned off. In this case, the battery pack is in the discharging state. The control module 501 controls, within a time period of 0.3 ms to 0.4 ms, the first switch tube S3 to be turned off and the second switch tube S4 to be turned on. In this case, the battery pack is in the charging state. Cyclic charging and discharging are performed by analogy. In other words, the control module 501 alternately turns on the first switch tube S3 and the second switch tube S4 at a time periodicity of 0.2 ms, that is, the second preset frequency is 5 kHz.

It should be noted that the battery pack may be in one of the foregoing states. For example, the control module 501 may control only the first switch tube S3 to be turned on, the second switch tube S4 to be turned off, and the battery pack to be in the discharging state; or the control module 501 may control only the first switch tube S3 to be turned off, the second switch tube S4 to be turned on, and the battery pack to be in the charging state. The foregoing example is merely a specific implementation, and should not be construed as a limitation on this application.

Further, In one embodiment, when the first switch tube S3 is turned on and the second switch tube S4 is turned off, the positive electrode B+ of the battery pack, the first winding, the first switch tube S3, and the negative electrode B− of the battery pack may form a closed loop. In this case, the battery pack is in a discharging state, and a current of the first winding increases along a first direction. When the second switch tube S4 is turned on and the first switch tube S3 is turned off, energy obtained by the first winding in the first inductor L2 when the battery pack is in the discharging state is released through the second winding in the first inductor L2. That is, the second winding, the positive electrode B+ of the battery pack, the negative electrode B− of the battery pack, and the second switch tube S4 form a closed loop. The second winding charges the battery pack. In this case, the battery pack is in a charging state, and a current of the second winding decreases along a second direction. In addition, after the current of the second winding decreases to a first preset threshold, for example, 0, the control module 501 does not change an on/off state of each switch tube, to be specific, the second switch tube S4 is turned on, the first switch tube S3 is turned off, and the battery pack is in the discharging state. In this case, the positive electrode B+ of the battery pack, the second winding, the second switch tube S4, and the negative electrode B− of the battery pack form a closed loop, and the current of the second winding increases along the first direction. In addition, after the current of the second winding increases to the second preset threshold, for example, 10 A, the first switch tube S3 is turned on, the second switch tube S4 is turned off, and energy obtained by the second winding of the first inductor L2 when the battery pack is in the discharging state is released through the first winding of the first inductor L2. That is, the first winding, the positive electrode B+ of the battery pack, the negative electrode B− of the battery pack, and the first switch tube S3 form a closed loop. The first winding charges the battery pack. In this case, the battery pack is in a charging state, and a current of the first winding decreases along a second direction. As can be learned, because on/off states of the switch tubes may be the same (to be specific, the second switch tube S4 is turned on and the first switch tube S3 is turned off or the first switch tube S3 is turned on and the second switch tube S4 is turned off) in the charging state and the discharging state, the on/off states of the switch tubes do not need to be frequently switched. Therefore, a switch loss is reduced, and heating efficiency of the battery control circuit is further improved.

For example, the control module 501 controls, within a time period of 0 ms to 0.1 ms, the first switch tube S3 to be turned on and the second switch tube S4 to be turned off, and the current of the first winding increases along the first direction. In this case, the battery pack is in the discharging state. The control module 501 controls, within a time period of 0.1 ms to 0.2 ms, the second switch tube S4 to be turned on and the first switch tube S3 to be turned off, and the current of the second winding decreases along the second direction. In this case, the battery pack is in the charging state. A difference is that the control module 501 keeps controlling, within a time period of 0.2 ms to 0.3 ms, the second switch tube S4 to be turned on and the first switch tube S3 to be turned off, and the current of the second winding increases along the first direction. In this case, the battery pack is in the discharging state. The control module 501 controls, within a time period of 0.3 ms to 0.4 ms, the first switch tube S3 to be turned on and the second switch tube S4 to be turned off, and the current of the first winding decreases along the second direction. In this case, the battery pack is in the charging state. In other words, the control module 501 alternately turns on the first switch tube S3 and the second switch tube S4 at a time periodicity of 0.4 ms. In this case, the second preset frequency is 2.5 kHz.

In one embodiment, the battery control circuit further includes a current detection module 503. The current detection module 503 may detect the current of the first winding and the current of the second winding. For example, when the battery pack is in the discharging state, the current detection module 503 detects the current of the first winding; and when the battery pack is in the charging state, the current detection module 503 detects the current of the second winding. The control module 501 may obtain the current of the first winding and the current of the second winding that are detected by the current detection module 503, and determine the second preset frequency based on the current of the first winding and the current of the second winding. For example, the current detection module 503 may be specifically a resistance, a current sensor, or the like.

For example, after controlling the first switch tube S3 to be turned on and the second switch tube S4 to be turned off, the control module 501 may obtain the current of the first winding, and denote a moment at which the current of the first winding increases to a first preset current as a first moment T3; and control, at the first moment T3, the first switch tube S3 to be turned off and the second switch tube S4 to be turned on, obtain the current of the second winding, denote a moment at which the current of the second winding decreases to a second preset current as a second moment T4, and control, at the second moment T4, the first switch tube S3 to be turned on and the second switch tube S4 to be turned off. The control module 501 may determine the second preset frequency f2 based on a time interval between the first moment T3 and the second moment T4, that is, f2=1/(|T3−T4|).

For another example, after controlling the first switch tube S3 to be turned on and the second switch tube S4 to be turned off, the control module 501 may obtain the current of the first winding, and denote a moment at which the current of the first winding increases to the first preset current as a first moment T5; and control, at the first moment T5, the first switch tube S3 to be turned off and the second switch tube S4 to be turned on, obtain the current of the second winding, and denote a moment at which the current of the second winding decreases to the second preset current as a second moment T6. In this case, the control module 501 does not change on/off states of the first switch tube and the second switch tube; controls, when the current of the second winding increases to the first preset current, the first switch tube S3 to be turned on and the second switch tube S4 to be turned off; and when the current of the first winding decreases to the second preset current threshold, controls the first switch tube S3 to be turned off and the second switch tube S4 to be turned on. The control module 501 may determine the second preset frequency f2′ based on a time interval between the first moment T5 and the second moment T6, that is, f2′=1/(2*|T5−T6|).

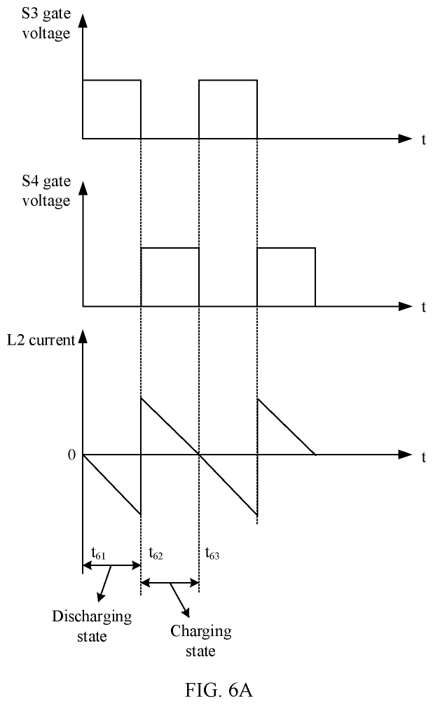

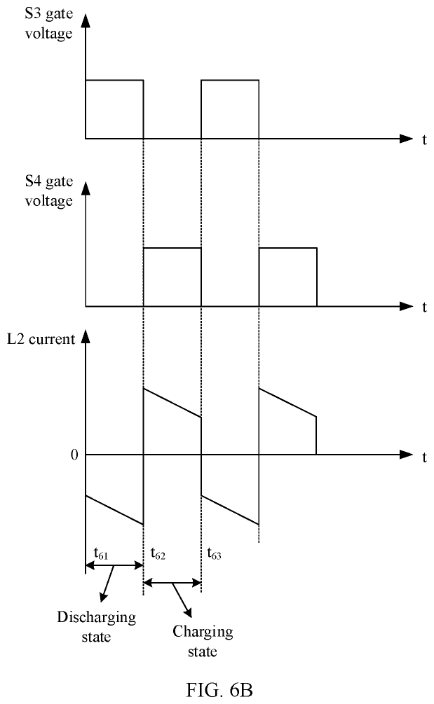

How the battery control circuit shown in FIG. 5 implements charging and discharging of the battery pack is described below by using examples with reference to FIG. 6A to FIG. 9B.

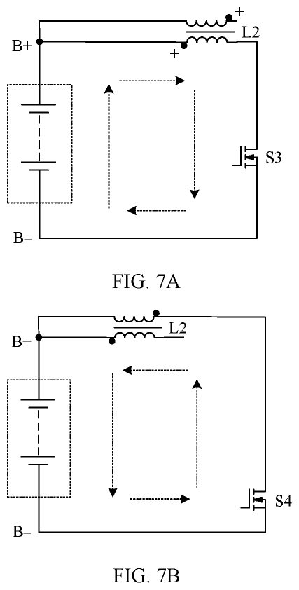

FIG. 6A is another schematic diagram of a waveform of a battery control circuit according to an embodiment of this application. As shown in FIG. 6A, in a time period from t₆₁ to t₆₂, the control module 501 sends a high electrical level to a third terminal (that is, a gate) of the first switch tube S3, and sends a low electrical level to a third terminal (that is, a gate) of the second switch tube S4. In this case, for a partial equivalent circuit diagram of the battery control circuit shown in FIG. 5, refer to FIG. 7A. As shown in FIG. 7A, the battery pack is discharged, and the positive electrode B+ of the battery pack, the first winding, the first switch tube S3, and the negative electrode B− of the battery pack form a closed loop. In this case, a current of the closed loop excites the first winding, and the current of the first winding increases, that is, the current of the first inductor L2 increases. Moreover, the current of the closed loop flows through an internal resistance of the battery pack, and generates Joule heat on the internal resistance of the battery pack. In other words, the battery pack may be discharged through the battery control circuit to heat the battery.

In a time period from t₆₂ to t₆₃, the control module 501 sends a low electrical level to a gate of the first switch tube S3, and sends a high electrical level to a gate of the second switch tube S4. In this case, for a partial equivalent circuit diagram of the battery control circuit shown in FIG. 5, refer to FIG. 7B. As shown in FIG. 7B, energy obtained by the first winding in the first inductor L2 when the battery pack is in the discharging state is released through the second winding in the first inductor L2. That is, the second winding, the positive electrode B+ of the battery pack, the negative electrode B− of the battery pack, and the second switch tube S4 form a closed loop to charge the battery pack. In this case, the second winding is demagnetized, and the current of the second winding decreases, that is, the current of the first inductor L2 decreases. Moreover, the current of the closed loop also flows through the internal resistance of the battery pack, and generates Joule heat on the internal resistance of the battery. In other words, the battery pack may be charged through the battery control circuit to heat the battery.

It may be understood that in this embodiment of this application, the schematic diagram of the waveform of the battery control circuit may further be shown in FIG. 6B. On and off of the first switch tube S3 and the second switch tube S4 are controlled based on the schematic diagram of the waveform shown in FIG. 6B. Obtained equivalent circuit diagrams are still shown in FIG. 7A and FIG. 7B. A difference between the schematic diagrams of the waveforms shown in FIG. 6B and FIG. 6A is that the first inductors L2 are different. In FIG. 6B, the first switch tube S3 is controlled to be turned on before the current of the first inductor L2 decreases to 0, and the current of the first inductor L2 is a trapezoidal wave. This embodiment of this application can reduce a current peak value in the battery control circuit, has a low requirement on a current stress of each switch tube, and has strong applicability.

This embodiment of this application is another possible implementation of the battery control circuit. Because the first switch tube and the second switch tube are alternately turned on, heating of the switch tubes is even, safety of the battery control circuit is good, and reliability is high.

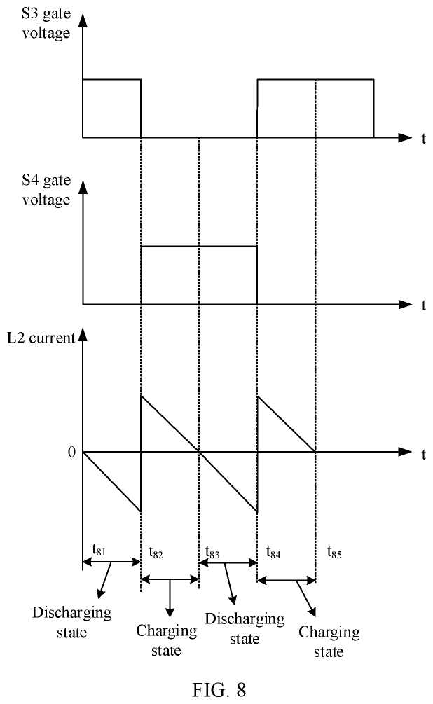

In one embodiment, FIG. 8 is another schematic diagram of a waveform of a battery control circuit according to an embodiment of this application. As shown in FIG. 8, when the first switch tube S3 is turned on and the second switch tube S4 is turned off, the battery pack may be in the discharging state or the charging state; and when the second switch tube S4 is turned on and the first switch tube S3 is turned off, the battery pack may be in the charging state or the discharging state.

In one embodiment, in a time period from t₈₁ to t₈₂, the control module 501 sends a high electrical level to a third terminal (that is, a gate) of the first switch tube S3, and sends a low electrical level to a third terminal (that is, a gate) of the second switch tube S4, and the battery pack is in the discharging state. In this case, a partial equivalent circuit diagram of the battery control circuit shown in FIG. 5 is still shown in FIG. 7A. A current direction in which the battery pack is discharged is a first direction. That is, the positive electrode B+ of the battery pack, the first winding, the first switch tube S3, and the negative electrode B− of the battery pack form a closed loop. In this case, a current of the closed loop excites the first winding, and the current of the first winding increases, that is, the current of the first inductor L2 increases.

In a time period from t₈₂ to t₈₃, the control module 501 sends a low electrical level to a gate of the first switch tube S3, and sends a high electrical level to a gate of the second switch tube S4, and the battery pack is in the charging state. In this case, a partial equivalent circuit diagram of the battery control circuit shown in FIG. 5 is still shown in FIG. 7B. Energy obtained by the first winding in the first inductor L2 when the battery pack is in the discharging state is released through the second winding in the first inductor L2. A current direction in which the battery pack is charged is a second direction. That is, the second winding, the positive electrode B+ of the battery pack, the negative electrode B− of the battery pack, and the second switch tube S4 form a closed loop to charge the battery pack. In this case, the second winding is demagnetized, and the current of the second winding decreases, that is, the current of the first inductor L2 decreases. It should be understood that the first direction is opposite to the second direction.

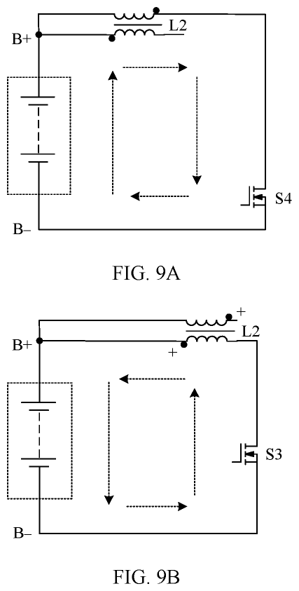

In a time period from t₈₃ to t₈₄, the control module 501 still sends a low electrical level to the gate of the first switch tube S3, and sends a high electrical level to the gate of the second switch tube S4, but the battery pack is in the discharging state. In this case, a partial equivalent circuit of the battery control circuit shown in FIG. 5 is shown in FIG. 9A. A current direction in which the battery pack is discharged is still a first direction. That is, the positive electrode B+ of the battery pack, the second winding, the second switch tube S4, and the negative electrode B− of the battery pack form a closed loop. In this case, a current of the closed loop excites the second winding, and the current of the second winding increases, that is, the current of the first inductor L2 increases.

In a time period from t₈₄ to t₈₅, the control module 501 sends a high electrical level to a gate of the first switch tube S3, and sends a low electrical level to a gate of the second switch tube S4, and the battery pack is in the charging state. In this case, a partial equivalent circuit of the battery control circuit shown in FIG. 5 is shown in FIG. 9B. Energy obtained by the second winding in the first inductor L2 when the battery pack is in the discharging state is released through the first winding in the first inductor L2. A current direction in which the battery pack is charged is a second direction. That is, the first winding, the positive electrode B+ of the battery pack, the negative electrode B− of the battery pack, and the first switch tube S3 form a closed loop to charge the battery pack. In this case, the first winding is demagnetized, and the current of the first winding decreases, that is, the current of the first inductor L2 decreases.

It may be understood that when the battery pack is in the discharging state, the current passes through an internal resistance of the battery pack along the first direction and generates Joule heat on the internal resistance of the battery; and when the battery pack is in the charging state, the current passes through the internal resistance of the battery pack along the second direction and generates Joule heat on the internal resistance of the battery. In other words, charging and discharging are implemented by using energy of the battery pack. Currents of charging and discharging both generate heat on an internal resistance of the battery pack to heat the battery. Therefore, heating efficiency is high.

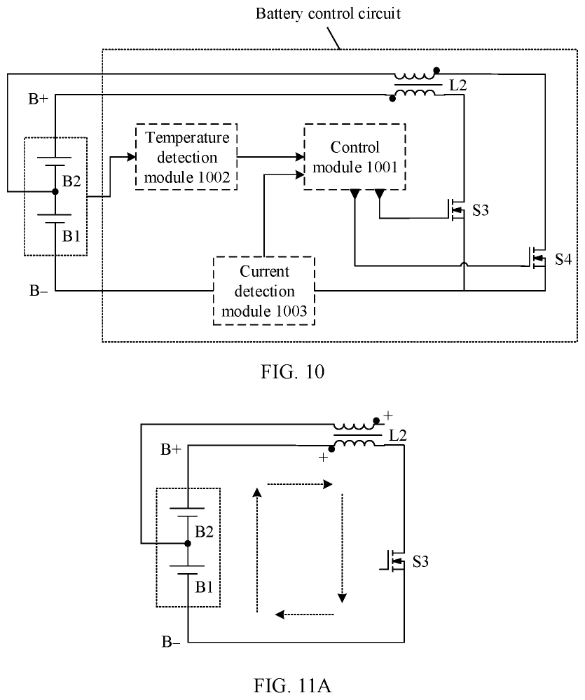

In one embodiment, FIG. 10 is another circuit principle diagram of a battery control circuit according to an embodiment of this application. As shown in FIG. 10, the battery pack includes a first electrochemical cell B1 and a second electrochemical cell B2, and a positive electrode of the first electrochemical cell B1 is coupled to a negative electrode of the second electrochemical cell B2. The battery control circuit in this embodiment of this application includes a first inductor L2, a first switch tube S3, and a second switch tube S4, the first inductor L2 includes a first winding and a second winding, and a first terminal of the first winding and a first terminal of the second winding are dotted terminals.

In one embodiment, for example, the first switch tube S3 and the second switch tube S4 are MOSFETs. The first terminal of the first winding is coupled to a positive electrode (that is, a positive electrode B+ of the battery pack) of the second electrochemical cell B2, a second terminal of the first winding is coupled to a first terminal (that is, a drain) of the first switch tube S3, and a second terminal (that is, a source) of the first switch tube S3 is coupled to a negative electrode (that is, a negative electrode B− of the battery pack) of the first electrochemical cell B1. A second terminal of the second winding is coupled to the positive electrode of the first electrochemical cell B1, the first terminal of the second winding is coupled to a first terminal (that is, a drain) of the second switch tube S4, and a second terminal (that is, a source) of the second switch tube S4 is coupled to the negative electrode (that is, the negative electrode B− of the battery pack) of the first electrochemical cell B1.

In one embodiment, the battery control circuit in this embodiment of this application further includes at least one of a control module 1001, a temperature detection module 1002, and a current detection module 1003. For specific descriptions, refer to the embodiment described above with reference to FIG. 5. Details are not described herein again.

In one embodiment, when the first switch tube S3 is turned on and the second switch tube S4 is turned off, the positive electrode B+ of the battery pack, the first winding, the first switch tube S3, and the negative electrode B− of the battery pack may form a closed loop. In this case, the first electrochemical cell B1 and the second electrochemical cell B2 are both in a discharging state, and a current of the first winding increases along a first direction. When the second switch tube S4 is turned on and the first switch tube S3 is turned off, energy obtained by the first winding in the first inductor L2 when the battery pack is in the discharging state is released through the second winding in the first inductor L2. That is, the second winding, the positive electrode of the first electrochemical cell B1, the negative electrode of the first electrochemical cell B1, and the second switch tube S4 form a closed loop, and the second winding charges the first electrochemical cell B1. In this case, the first electrochemical cell B1 is in a charging state, and a current of the second winding decreases along a second direction. The first direction is opposite to the second direction.

Further, in one embodiment, when the first switch tube S3 is turned on and the second switch tube S4 is turned off, the positive electrode B+ of the battery pack, the first winding, the first switch tube S3, and the negative electrode B− of the battery pack may form a closed loop. In this case, the first electrochemical cell B1 and the second electrochemical cell B2 are both in a discharging state, and a current of the first winding increases along a first direction. When the second switch tube S4 is turned on and the first switch tube S3 is turned off, energy obtained by the first winding in the first inductor L2 when the battery pack is in the discharging state is released through the second winding in the first inductor L2. That is, the second winding, the positive electrode of the first electrochemical cell B1, the negative electrode of the first electrochemical cell B1, and the second switch tube S4 form a closed loop, and the second winding charges the first electrochemical cell B1. In this case, the first electrochemical cell B1 is in a charging state, and a current of the second winding decreases along a second direction. In addition, after the current of the second winding decreases to a first preset threshold, for example, 0, the control module 1001 does not change an on/off state of each switch tube, to be specific, the second switch tube S4 is turned on, the first switch tube S3 is turned off, and the first electrochemical cell B1 is in the discharging state. In this case, the positive electrode of the first electrochemical cell B1, the second switch tube S4, and the negative electrode of the first electrochemical cell B1 form a closed loop, and the current of the second winding increases along the first direction. In addition, after the current of the second winding increases to the second preset threshold, for example, 10A, the first switch tube S3 is turned on, the second switch tube S4 is turned off, and energy obtained by the second winding of the first inductor L2 when the first electrochemical cell B1 is in the discharging state is released through the first winding of the first inductor L2. That is, the first winding, the positive electrode B+ of the battery pack, the negative electrode B− of the battery pack, and the first switch tube S3 form a closed loop. The first winding charges the battery pack. In this case, the battery pack is in a charging state, and a current of the first winding decreases along a second direction.

In this embodiment of this application, in one discharging and discharging cycle, the first electrochemical cell and the second electrochemical cell are simultaneously discharged, and only the first electrochemical cell is charged; or only the first electrochemical cell is discharged, and the first electrochemical cell and the second electrochemical cell are simultaneously charged. In this case, an amount of heat generated by the first electrochemical cell is greater than an amount of heat generated by the second electrochemical cell. This embodiment of this application may be applicable to different electrochemical cells. For example, a temperature withstand of the first electrochemical cell is less than that of the second electrochemical cell, and an internal resistance of the first electrochemical cell is greater than that of the second electrochemical cell. In other words, this embodiment of this application can better adapt to differences between electrochemical cells and has good applicability.

It may be understood that, in this embodiment of this application, an example in which the battery pack includes two electrochemical cell is used. In specific application, the battery pack may alternatively include more than two electrochemical cells. For example, the positive electrode of the first electrochemical cell is coupled to the negative electrode of the second electrochemical cell, and the positive electrode of the second electrochemical cell is coupled to a negative electrode of a third electrochemical cell. A positive electrode of the third electrochemical cell is the positive electrode of the battery pack, and the negative electrode of the first electrochemical cell is the negative electrode of the battery pack. In this case, the second terminal of the second winding may be connected to the positive electrode of the first electrochemical cell or the positive electrode of the second electrochemical cell (not shown in the figure).

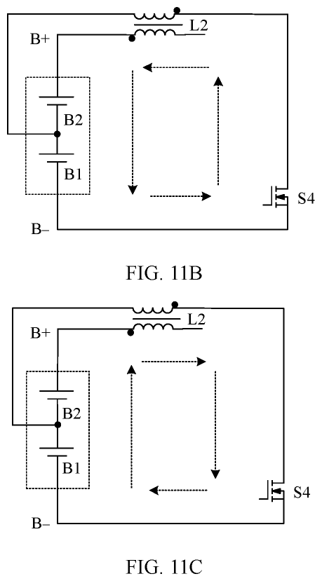

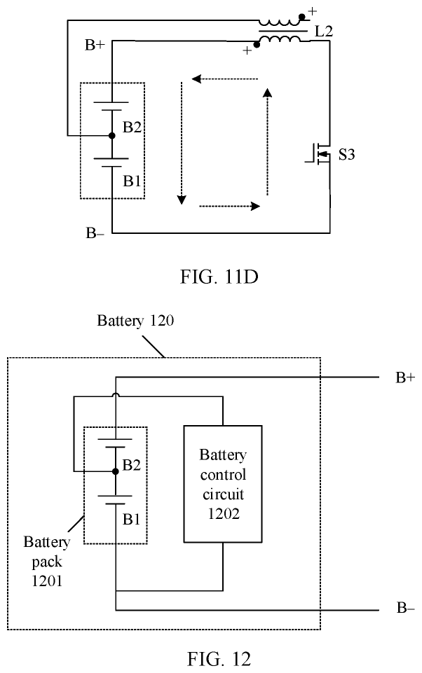

A difference between this embodiment of this application and the embodiment described above with reference to FIG. 5 is that the second terminal of the second winding in this embodiment of this application is coupled to the positive electrode of the first electrochemical cell B1 instead of the positive electrode of the battery pack. How the battery control circuit shown in FIG. 10 charges and discharges an electrochemical cell in a battery pack is described below with reference to FIG. 11A to FIG. 11D.

First, it should be noted that the schematic diagrams of the waveforms shown in FIG. 6A, FIG. 6B, and FIG. 8 are all applicable to the battery control circuit in this the embodiment of this application.

In one embodiment, with reference to the schematic diagram of the waveform shown in FIG. 6A, in a time period from t₆₁ to t₆₂, the control module 1001 sends a high electrical level to a third terminal (that is, a gate) of the first switch tube S3, and sends a low electrical level to a third terminal (that is, a gate) of the second switch tube S4. In this case, for a partial equivalent circuit diagram of the battery control circuit shown in FIG. 10, refer to FIG. 11A. As shown in FIG. 11A, the first electrochemical cell B1 and the second electrochemical cell B2 are discharged, and the positive electrode B+ of the battery pack, the first winding, the first switch tube S3, and the negative electrode B− of the battery pack form a closed loop. In this case, a current of the closed loop excites the first winding, and the current of the first winding increases, that is, the current of the first inductor L2 increases. Moreover, the current of the closed loop flows through an internal resistance of the battery pack, and generates Joule heat on the internal resistance of the battery pack. In other words, the battery pack may be discharged through the battery control circuit to heat the first electrochemical cell B1 and the second electrochemical cell B2.

In a time period from t₆₂ to t₆₃, the control module 1001 sends a low electrical level to a gate of the first switch tube S3, and sends a high electrical level to a gate of the second switch tube S4. In this case, for a partial equivalent circuit diagram of the battery control circuit shown in FIG. 10, refer to FIG. 11B. As shown in FIG. 11B, the second winding, the positive electrode of the first electrochemical cell B1, the negative electrode of the first electrochemical cell B1, and the second switch tube S4 form a closed loop to charge the first electrochemical cell B1. In this case, the second winding is demagnetized, and the current of the second winding decreases, that is, the current of the first inductor L2 decreases. Moreover, a current of the closed loop flows through an internal resistance of the first electrochemical cell B1, and generates Joule heat on the internal resistance of the first electrochemical cell B1. In other words, the battery control circuit heats only the first electrochemical cell B1 in a time period from t₆₂ to t₆₃.

In one embodiment, with reference to the schematic diagram of the waveform shown in FIG. 6B, the control module 1001 may control on and off of the first switch tube S3 and the second switch tube S4 based on the schematic diagram of the waveform shown in FIG. 6B. Obtained equivalent circuit diagrams are still shown in FIG. 11A and FIG. 11B. Details are not described herein again.

In one embodiment, with reference to the schematic diagram of the waveform shown in FIG. 8, when the first switch tube S3 is turned on and the second switch tube S4 is turned off, the battery pack may be in the discharging state or the charging state; and when the second switch tube S4 is turned on and the first switch tube S3 is turned off, the first electrochemical cell B1 may be in the charging state or the discharging state.

In one embodiment, in a time period from t₈₁ to t₈₂, the control module 1001 sends a high electrical level to a third terminal (that is, a gate) of the first switch tube S3, and sends a low electrical level to a third terminal (that is, a gate) of the second switch tube S4, and the first electrochemical cell B1 and the second electrochemical cell B2 are both in the discharging state. In this case, a partial equivalent circuit diagram of the battery control circuit shown in FIG. 10 is still shown in FIG. 11A. A current direction in which the battery pack is discharged is a first direction. That is, the positive electrode B+ of the battery pack, the first winding, the first switch tube S3, and the negative electrode B− of the battery pack form a closed loop. In this case, a current of the closed loop excites the first winding, and the current of the first winding increases, that is, the current of the first inductor L2 increases.

In a time period from t₈₂ to t₈₃, the control module 1001 sends a low electrical level to a gate of the first switch tube S3, and sends a high electrical level to a gate of the second switch tube S4, and the first electrochemical cell B1 is in the charging state. In this case, a partial equivalent circuit diagram of the battery control circuit shown in FIG. 10 is still shown in FIG. 11B. Energy obtained by the first winding in the first inductor L2 when the battery pack is in the discharging state is released through the second winding in the first inductor L2. A current direction in which the battery pack is charged is a second direction. That is, the second winding, the positive electrode of the first electrochemical cell B1, the negative electrode of the first electrochemical cell B1, and the second switch tube S4 form a closed loop to charge the first electrochemical cell B1. In this case, the second winding is demagnetized, and the current of the second winding decreases, that is, the current of the first inductor L2 decreases. It should be understood that the first direction is opposite to the second direction.

In a time period from t₈₃ to t₈₄, the control module 1001 still sends a low electrical level to the gate of the first switch tube S3, and sends a high electrical level to the gate of the second switch tube S4, but the first electrochemical cell B1 is in the discharging state. In this case, for a partial equivalent circuit of the battery control circuit shown in FIG. 10 is shown in FIG. 11C. A current direction in which the first electrochemical cell B1 is discharged is still a first direction. That is, the positive electrode of the first electrochemical cell B1, the second winding, the second switch tube S4, and the negative electrode of the first electrochemical cell B1 form a closed loop. In this case, a current of the closed loop excites the second winding, and the current of the second winding increases, that is, the current of the first inductor L2 increases.

In a time period from t₈₄ to t₈₅, the control module 1001 sends a high electrical level to a gate of the first switch tube S3, and sends a low electrical level to a gate of the second switch tube S4, and the first electrochemical cell B1 and the second electrochemical cell B2 are both in the charging state. In this case, a partial equivalent circuit of the battery control circuit shown in FIG. 10 is shown in FIG. 11D. Energy obtained by the second winding in the first inductor L2 when the first electrochemical cell B1 is in the discharging state is released through the first winding in the first inductor L2. A current direction in which the battery pack is charged is a second direction. That is, the first winding, the positive electrode B+ of the battery pack, the negative electrode B− of the battery pack, and the first switch tube S3 form a closed loop to charge the battery pack. In this case, the first winding is demagnetized, and the current of the first winding decreases, that is, the current of the first inductor L2 decreases.

It may be understood that when the first electrochemical cell B1 and the second electrochemical cell B2 are in the discharging state, Joule heat is generated on internal resistances of the first electrochemical cell B1 and the second electrochemical cell B2; and when the first electrochemical cell B1 is in the charging state, Joule heat is generated only on an internal resistance of the first electrochemical cell B1.

In one embodiment, the battery control circuit described above with reference to FIG. 10 to FIG. 11D and the battery may be encapsulated together as a part of the battery. FIG. 12 shows another battery according to an embodiment of this application. As shown in FIG. 12, an intermediate tap is drawn from a battery pack 1201, and is connected to a terminal of a battery control circuit 1202. Another terminal of the battery control circuit 1202 is connected to a negative electrode of the battery pack 1201.

An embodiment of this application further provides an electronic device. The electronic device is provided with a load and the battery shown in FIG. 1 or FIG. 12. The battery is configured with a battery heating function. In other words, the battery is configured with any battery control circuit described above. For example, the electronic device may be applicable to a communication system, and the load may be specifically implemented as a base station device in communication. The electronic device may alternatively be applicable to a photovoltaic system, and the load may be specifically implemented as a photovoltaic inverter. The electronic device may alternatively be specifically implemented as an electric vehicle, a headset, or the like.

It should be noted that the foregoing terms “first” and “second” are used only for description purposes, and cannot be understood as indicating or implying relative importance.

The units described as separate components may or may not be physically separated, and the components shown as units may or may not be physical units, that is, may be located in one place, or may be distributed on a plurality of network elements. Some or all of the units may be selected based on actual requirements to achieve the objectives of the solutions in the embodiments.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A battery control circuit, comprising
a first inductor;
a first switch tube;
a second switch tube;
a first diode; and
a second diode, wherein the battery control circuit is connected in parallel between a positive electrode and a negative electrode of a battery pack, wherein a first terminal of the first switch tube and a cathode of the first diode are both coupled to the positive electrode of the battery pack, and wherein a second terminal of the first switch tube is coupled to a terminal of the first inductor and a cathode of the second diode,
wherein an anode of the first diode is coupled to another terminal of the first inductor and a first terminal of the second switch tube, and wherein a second terminal of the second switch tube and an anode of the second diode are both coupled to the negative electrode of the battery pack, wherein the first switch tube and the second switch tube are simultaneously turned on in response to that the battery pack is in a discharging state, or the first switch tube and the second switch tube are simultaneously turned off in response to that the battery pack is in a charging state.

2. The battery control circuit according to claim 1, wherein the battery control circuit further comprises a control module coupled to a third terminal of the first switch tube and a third terminal of the second switch tube.

3. The battery control circuit according to claim 2, wherein the battery control circuit further comprises a temperature detection module configured to: detect a temperature of the battery pack, and send the temperature of the battery pack to the control module; and
wherein the control module is configured to: when the temperature of the battery pack is lower than a preset temperature, control the first switch tube and the second switch tube to simultaneously switch between an on state and an off state at a preset frequency.

4. The battery control circuit according to claim 3, wherein the battery control circuit further comprises a current detection module configured to detect a current of the first inductor; and
wherein the control module is configured to: obtain the current of the first inductor detected by the current detection module, and determine the preset frequency.

5. The battery control circuit according to claim 4, wherein the preset frequency is determined by the control module based on a time interval between a first moment and a second moment, wherein the first moment is a moment at which the control module detects that the current of the first inductor increases to a first preset current, and wherein the second moment is a moment at which the control module detects that the current of the first inductor decreases to a second preset current.

6. A battery control circuit comprising
a first inductor, wherein the first inductor comprises a first winding and a second winding, and a first terminal of the first winding and a first terminal of the second winding are dotted terminals, and wherein the battery control circuit is connected in parallel between a positive electrode and a negative electrode of a battery pack;
a first switch tube, and
a second switch tube, wherein the first terminal of the first winding is coupled to the positive electrode of the battery pack, a second terminal of the first winding is coupled to a first terminal of the first switch tube, and a second terminal of the first switch tube is coupled to the negative electrode of the battery pack, and wherein a second terminal of the second winding is coupled to the positive electrode of the battery pack, wherein the first terminal of the second winding is coupled to a first terminal of the second switch tube, and wherein a second terminal of the second switch tube is coupled to the negative electrode of the battery pack, and wherein the first switch tube and the second switch tube are alternately turned on.

7. The battery control circuit according to claim 6, wherein when the first switch tube is turned on and the second switch tube is turned off, the battery pack is in a discharging state; or
when the second switch tube is turned on and the first switch tube is turned off, the battery pack is in a charging state.

8. The battery control circuit according to claim 6, wherein when the first switch tube is turned on and the second switch tube is turned off, if a current direction of the first winding is a first direction, the battery pack is in a discharging state;
when the second switch tube is turned on and the first switch tube is turned off, if a current direction of the second winding is a second direction, the battery pack is in a charging state;
when the second switch tube is turned on and the first switch tube is turned off, if a current direction of the second winding is a first direction, the battery pack is in a discharging state; or
when the first switch tube is turned on and the second switch tube is turned off, if a current direction of the first winding is a second direction, the battery pack is in a charging state, wherein the first direction is opposite to the second direction.

9. The battery control circuit claim 6, wherein the battery control circuit further comprises a control module coupled to a third terminal of the first switch tube and a third terminal of the second switch tube.

10. The battery control circuit according to claim 9, wherein the battery control circuit further comprises a temperature detection module configured to: detect a temperature of the battery pack, and send the temperature of the battery pack to the control module; and
wherein the control module is configured to: when the temperature of the battery pack is lower than a preset temperature, control, at a preset frequency, the first switch tube and the second switch tube to be alternately turned on.

11. The battery control circuit according to claim 10, wherein the battery control circuit further comprises a current detection module configured to detect a current of the first winding and a current of the second winding; and
wherein the control module is configured to: obtain the current of the first winding and the current of the second winding that are detected by the current detection module, and determine the preset frequency.

12. The battery control circuit according to claim 11, wherein the preset frequency is determined by the control module based on a time interval between a first moment and a second moment, wherein the first moment is a moment at which the control module detects that the current of the first winding increases to a first preset current, and wherein the second moment is a moment at which the control module detects that the current of the second winding decreases to a second preset current.

13. A battery control circuit, comprising:
a first inductor, wherein the first inductor comprises a first winding and a second winding, and wherein a first terminal of the first winding and a first terminal of the second winding are dotted terminals;
a first switch tube; and
a second switch tube, wherein the battery control circuit is applicable to a battery pack, wherein the battery pack comprises a first electrochemical cell and a second electrochemical cell, and wherein a positive electrode of the first electrochemical cell is coupled to a negative electrode of the second electrochemical cell;
wherein the first terminal of the first winding is coupled to a positive electrode of the second electrochemical cell, wherein a second terminal of the first winding is coupled to a first terminal of the first switch tube, and wherein a second terminal of the first switch tube is coupled to a negative electrode of the first electrochemical cell; and
wherein a second terminal of the second winding is coupled to the positive electrode of the first electrochemical cell, wherein the first terminal of the second winding is coupled to a first terminal of the second switch tube, wherein a second terminal of the second switch tube is coupled to the negative electrode of the first electrochemical cell, and wherein the first switch tube and the second switch tube are alternately turned on.

14. The battery control circuit according to claim 13, wherein when the first switch tube is turned on and the second switch tube is turned off, the first electrochemical cell and the second electrochemical cell are in a discharging state; or
when the second switch tube is turned on and the first switch tube is turned off, the first electrochemical cell is in a charging state.

15. The battery control circuit according to claim 13, wherein when the first switch tube is turned on and the second switch tube is turned off, if a current direction of the first winding is a first direction, the first electrochemical cell and the second electrochemical cell are both in a discharging state;
when the second switch tube is turned on and the first switch tube is turned off, if a current direction of the second winding is a second direction, the first electrochemical cell is in a charging state;
when the second switch tube is turned on and the first switch tube is turned off, if a current direction of the second winding is a first direction, the first electrochemical cell is in a discharging state; or
when the first switch tube is turned on and the second switch tube is turned off, if a current direction of the first winding is a second direction, the first electrochemical cell and the second electrochemical cell are in a charging state.

16. The battery control circuit according to claim 13, wherein the battery control circuit further comprises a control module coupled to a third terminal of the first switch tube and a third terminal of the second switch tube.

17. The battery control circuit according to claim 16, wherein the battery control circuit further comprises a temperature detection module configured to: detect temperatures of the first electrochemical cell and the second electrochemical cell, and send the temperatures of the first electrochemical cell and the second electrochemical cell to the control module; and
wherein the control module is configured to: when the temperature of at least one of the first electrochemical cell and the second electrochemical cell is lower than a preset temperature, control, at a preset frequency, the first switch tube and the second switch tube to be alternately turned on.

18. The battery control circuit according to claim 17, wherein the battery control circuit further comprises a current detection module configured to detect a current of the first winding and a current of the second winding; and
wherein the control module is configured to: obtain the current of the first winding and the current of the second winding that are detected by the current detection module, and determine the preset frequency.

19. The battery control circuit according to claim 11, wherein the preset frequency is determined by the control module based on a time interval between a first moment and a second moment, wherein the first moment is a moment at which the control module detects that the current of the first winding increases to a first preset current, and wherein the second moment is a moment at which the control module detects that the current of the second winding decreases to a second preset current.
